(19) United States
(12) Patent Application Publication
(10) Pub. No.: US 2024/0058984 A1
(43) Pub. Date: Feb. 22, 2024

(54) APPARATUS FOR MANUFACTURING ECO-FRIENDLY STRAW

(71) Applicant: SUNGWANGENF. CO., LTD, Gimcheon-si (KR)

(72) Inventor: Ki-Deug KIM, Gimcheon-si (KR)

(73) Assignee: SUNGWANGENF. CO., LTD, Gimcheon-si (KR)

(21) Appl. No.: 17/976,357

(22) Filed: Oct. 28, 2022

(30) Foreign Application Priority Data
Aug. 16, 2022 (KR) 10-2022-0101780

(51) Int. Cl. B27M 1/08; B27M 3/24

(52) U.S. Cl. CPC B27M 1/08; B27M 3/24; A47G 21/18

(57) ABSTRACT

Proposed is an apparatus for manufacturing eco-friendly straws and, more particularly, an apparatus for manufacturing eco-friendly straws, which prevents environmental pollution by using wood as a raw material for easy recycling and waste treatment, and improves manufacturing efficiency and product quality by automatically performing all manufacturing processes. The apparatus includes a supply unit configured to supply a raw material, a processing unit configured to process the raw material, and a transfer unit configured to move the raw material supplied from the supply unit to a position for processing in the processing unit.

### CROSS REFERENCE TO RELATED APPLICATION

The present application claims priority to Korean Patent Application No. 10-2022-0101780, filed Aug. 16, 2022, the entire contents of which is incorporated herein for all purposes by this reference.

### BACKGROUND OF THE INVENTION

### Field of the Invention

The present disclosure relates to an apparatus for manufacturing eco-friendly straws and, more particularly, to an apparatus for manufacturing eco-friendly straws, which prevents environmental pollution by using wood as a raw material for easy recycling and waste treatment, and improves manufacturing efficiency and product quality by automatically performing all manufacturing processes.

### Description of the Related Art

Plastic straws are the main culprit of environmental pollution and are emerging as a major problem worldwide. As the demand for favorite beverages such as coffee increases, the use of disposable plastic straws has also increased significantly, and the resultant environmental pollution has become a problem that must be addressed. In order to solve this problem, it is necessary to develop eco-friendly straws that do not cause environmental pollution. Recently, countries including the United States, China, Germany, the United Kingdom, and France have gradually banned the use of single-use plastic products, including plastic straws.

Currently, in the foodservice industry, products made mainly of paper, which is easily disposable and highly recyclable, are being introduced as a substitute for plastic straws, containers, and packaging materials. When straws, containers, packaging materials are manufactured using paper as the main raw material, they may be easily disposed of as combustible waste and may be recycled with less fuel consumption, thereby reducing environmental pollution.

Referring to FIG. 1, Korean Patent Application Publication No. 10-2020-0047393 discloses a paper straw and a manufacturing method thereof, including: applying an adhesive along the longitudinal direction of a broad-width paper fabric drawn out from a paper fabric on a roll and drying the adhesive; adjusting the position of the broad-width paper fabric to which the adhesive is applied; slitting a plurality of narrow-width paper fabrics having long sides while following the adhesive application part of the position-controlled broad-width paper fabric; forming an empty paper tube where a double joint is formed by overlapping any one side of the narrow-width paper fabric coated with adhesive and the other side of the paper fabric while each of the narrow-width paper fabrics coated with adhesive is dried to form a circle or oval by a paper tube forming unit; forming the double joint that is not easily separated by heating the double joint of the paper tube at least twice with a heating unit and pressing it with a roller; pulling the paper tube formed from the paper tube forming unit by a predetermined length toward a cutting unit by a paper tube pulling unit; and cutting the paper tube pulled by the paper tube pulling unit to a predetermined length that can be used as a straw by the cutting unit.

Although the paper straw described in Korean Patent Application Publication No. 10-2020-0047393 has the advantage of being easy to dispose of and renewable since paper is the main material, the problem with the paper straw is that in order to prevent the paper from getting wet even when it comes into contact with water, the surface of the paper needs to be coated. Since coating also has adverse effects on the environment, it is impossible to manufacture a 100 percent eco-friendly product.

Moreover, in order to manufacture straws using paper, equipment with a fairly complex structure is required, which increases the manufacturing cost.

Therefore, the development of eco-friendly straws that are easy to dispose of and recycle, are resistant to softening and loosening even when kept in a hot or cold beverage for a long time, and can be supplied in large quantities at a low price is required.

Furthermore, Korean Patent No. 10-2302399 discloses a high-speed manufacturing apparatus for eco-friendly straws, including: a supply unit that supplies clogged cylindrical wood as a raw material; a processing unit that performs the process of shaping the raw material into straw form; and a collection unit that collects processed wooden straws. Yet, a problem with this case is that a level difference occurs inside a final wooden straw product because a drilling device is inserted by a predetermined depth from each direction of the raw material. In addition, since compressed air is sprayed in the direction of the straw simply from a position adjacent to the straw, it is difficult to remove a small amount of wood residue that is stuck to the inner wall of the straw after drilling.

When such a small amount of wood residue is inhaled with a beverage when a user drinks the beverage, it not only causes the user considerable discomfort but is also not good for hygiene, posing a problem with the use of wooden straws.

### DOCUMENTS OF RELATED ART

(Patent Document 0001) Korean Patent Application Publication No. 10-2020-0047393 (Published May 7, 2020)
(Patent Document 0002) Korean Patent No. 10-2302399

### SUMMARY OF THE INVENTION

Accordingly, the present disclosure has been made to solve the problems of the related art, and an objective of the present disclosure is to provide an apparatus for manufacturing eco-friendly straws, which prevents environmental pollution by using wood as a raw material and forming a hollow in the raw material to use it as a straw. These eco-friendly straws are easy to recycle, and the manufacturing process is also simple, leading to lower manufacturing costs.

An objective of the present disclosure is to provide an apparatus for manufacturing eco-friendly straws, which improves hygiene by completely removing foreign matter from the inside of the straw by adding polishing and foreign matter removal processes after hollow processing, considering that foreign matter may remain inside the hollow after processing because the straw is processed in a way that forms the hollow in the wood, which is the raw material.

In order to achieve the above objectives, according to an embodiment of the present disclosure, there is provided provide an apparatus for manufacturing eco-friendly straws, the apparatus including: a supply unit configured to supply a raw material; a processing unit configured to process the raw material; and a transfer unit configured to move the raw material supplied from the supply unit to a position for processing in the processing unit.

The processing unit may include: a main body; a processing support plate installed along a longitudinal direction on each side of the main body, and in which processing grooves into which the raw material is inserted are formed at regular intervals on an upper portion thereof; and a drilling device installed on a side of the main body to drill a hole in the raw material.

The apparatus for manufacturing eco-friendly straws further includes: a polishing unit provided at a rear of the main body to polish a straw processed, wherein the polishing unit may include: a polishing device installed on a first side of the main body to polish a hollow of the straw; and a foreign matter removal device installed to face the polishing device on a second side of the main body to remove foreign matter from the hollow of the straw.

At this time, two pairs of the polishing devices and foreign matter removal devices may be sequentially installed along the longitudinal direction in the rear of the main body, and the polishing device located front and the polishing device located rear may be installed diagonally opposite to each other with respect to the main body.

Meanwhile, the polishing device may include: a polishing mounting plate installed to be movable on an auxiliary support installed on a side of the main body; a polisher installed to be rotatable on the polishing mounting plate to polish an inner circumferential surface of the straw; a drive motor installed on the polishing mounting plate to rotate the polisher; and a polishing actuator installed on an upper first side of the auxiliary support to move the polishing mounting plate, wherein the polishing actuator may consist of a motor to move a polishing rod connected to the polishing mounting plate with a constant force and speed.

The foreign matter removal device may include: a moving plate installed to be movable on an auxiliary support installed on a side of the main body; a spray mounting plate installed at an end of the moving plate; a spray pipe installed on the spray mounting plate to spray compressed air into the hollow of the straw; a compressed air distributor installed on an upper first side of the moving plate to equally distribute the compressed air supplied from a compressed air supply device to the spray pipe; and a spray actuator installed on an upper first side of the auxiliary support to move the moving plate.

At this time, when the end of the polisher of the polishing device is inserted into the hollow of the straw and reaches a set position, the spray pipe of the foreign matter removal device may be inserted into the hollow of the straw by the foreign matter removal device.

In addition, the polisher may be inserted to a position where it does not collide with the spray pipe before moving in the opposite direction.

The present disclosure has the following effects by the above configurations.

An apparatus for manufacturing eco-friendly straws of the present disclosure includes a supply unit that supplies a raw material, a processing unit that processes the raw material into straw shape, and a transfer unit that transports the raw material. By using wood as a raw material, the apparatus for manufacturing eco-friendly straws can prevent environmental pollution and can reduce manufacturing costs since these eco-friendly straws are easy to recycle and the manufacturing process thereof is simple.

Furthermore, the apparatus for manufacturing eco-friendly straws of the present disclosure can improve hygiene by completely removing foreign matter from the inside of the straw by adding polishing and foreign matter removal processes after hollow processing, considering that foreign matter may remain inside the hollow after processing because the straw is processed in a way that forms the hollow in the wood, which is the raw material.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram of a conventional straw manufacturing apparatus;

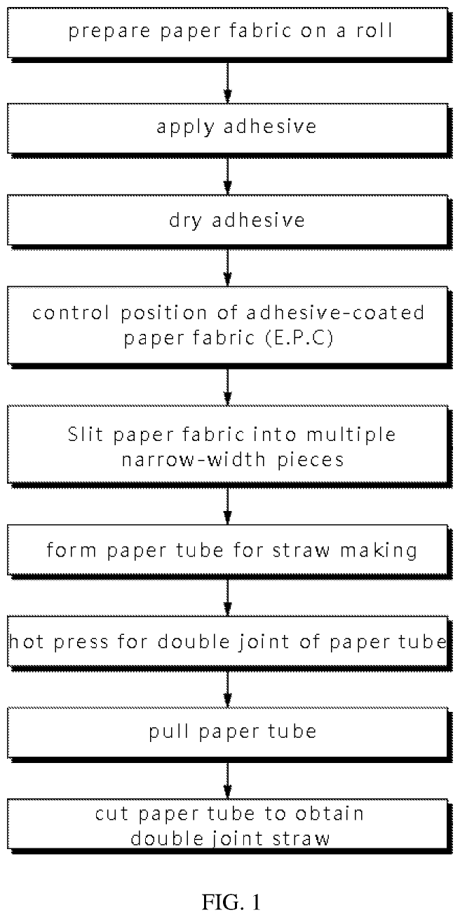

FIG. 2 is a side conceptual view of an apparatus for manufacturing eco-friendly straws according to the present disclosure;

FIG. 3 is a perspective view of a processing unit of the apparatus for manufacturing eco-friendly straws according to the present disclosure;

FIG. 4 is a front conceptual view of the processing unit of the apparatus for manufacturing eco-friendly straws according to the present disclosure;

FIG. 5 is a perspective view of a fixing device constituting the processing unit of the apparatus for manufacturing eco-friendly straws according to the present disclosure;

FIG. 6 is a conceptual view of a supply unit of the apparatus for manufacturing eco-friendly straws according to the present disclosure;

FIG. 7 is a perspective view of a transfer unit of the apparatus for manufacturing eco-friendly straws according to the present disclosure;

FIGS. 8A to 8E are conceptual views showing the operating state of the transfer unit of the apparatus for manufacturing eco-friendly straws according to the present disclosure;

FIG. 9 is a perspective view of a discharge unit of the apparatus for manufacturing eco-friendly straws according to the present disclosure;

FIG. 10 is a conceptual view showing the operating state of the discharge unit of the apparatus for manufacturing eco-friendly straws according to the present disclosure;

FIG. 11 is a conceptual view showing a step in which a raw material is processed in the apparatus for manufacturing eco-friendly straws according to the present disclosure;

FIG. 12 is an enlarged view of a polishing unit of the apparatus for manufacturing eco-friendly straws according to the present disclosure;

FIGS. 13A to 13C are conceptual views of a polisher of the apparatus for manufacturing eco-friendly straws according to the present disclosure;

FIGS. 14A and 14B are conceptual views of a spray pipe of the apparatus for manufacturing eco-friendly straws according to the present disclosure;

FIG. 15 is a conceptual view showing a process in which the inside of a straw is polished by a polishing device of the apparatus for manufacturing eco-friendly straws according to the present disclosure; and

FIG. 16 is a cross-sectional view of a straw manufactured by the conventional straw manufacturing apparatus.

### DETAILED DESCRIPTION OF THE INVENTION

Hereinafter, preferred embodiments of the present disclosure will be described in more detail with reference to the accompanying drawings. The same reference numerals are used for the same components in the drawings, and repeated descriptions of the same components are omitted. In addition, it should be understood that the present disclosure may be implemented in many different forms and is not limited to the described embodiments.

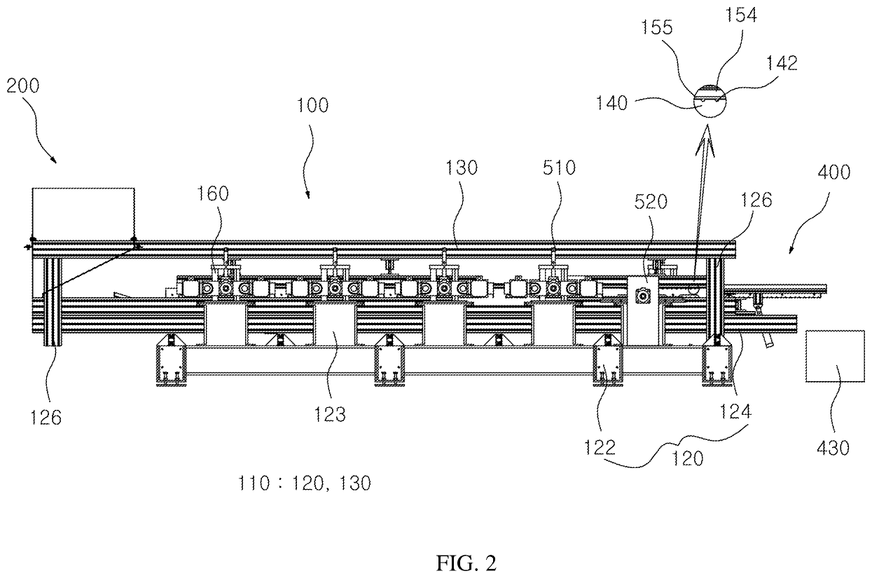

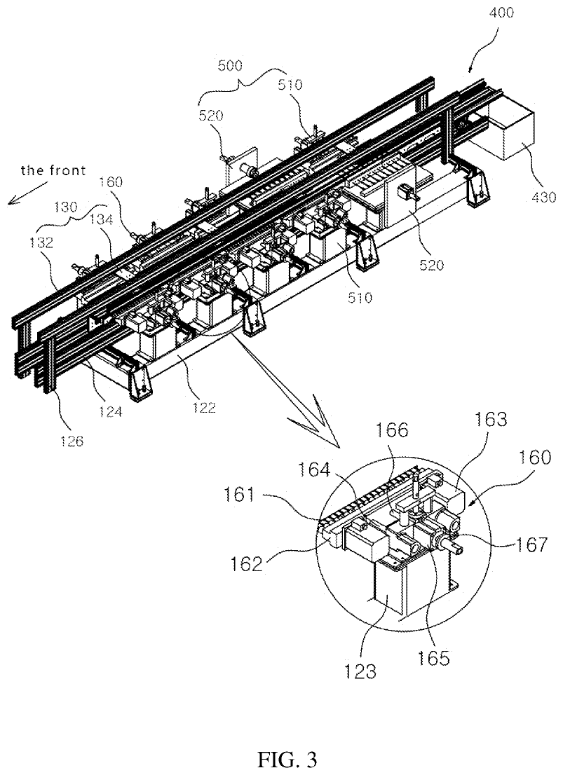

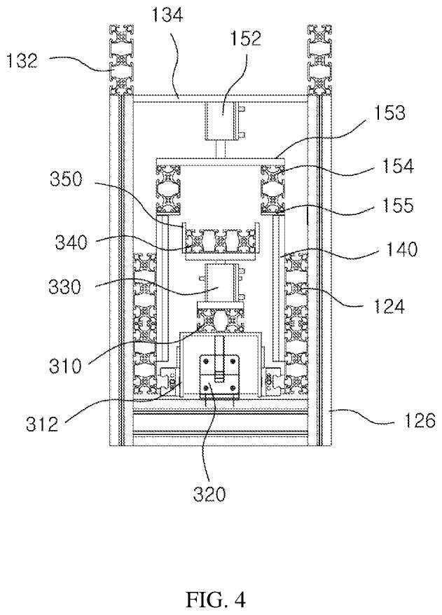

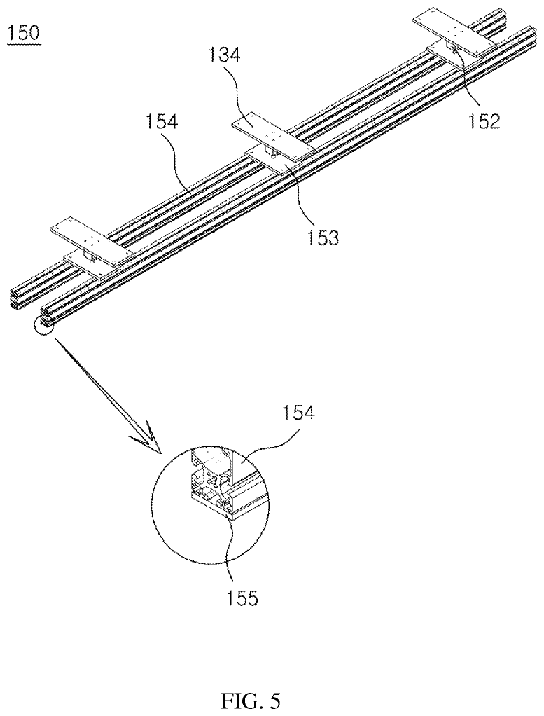

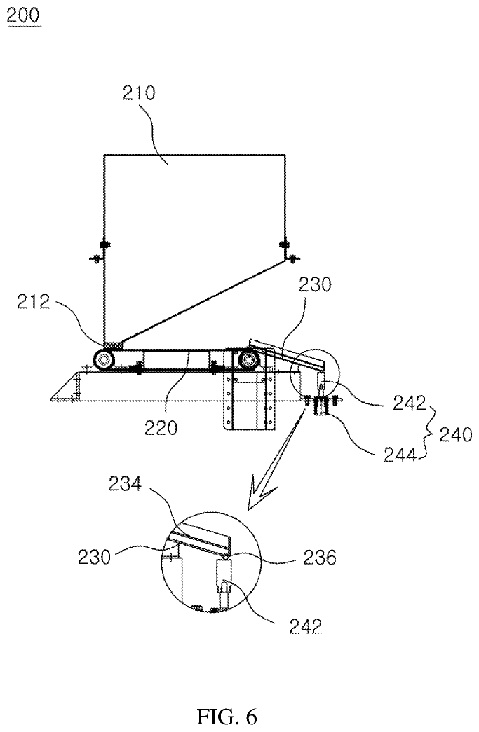

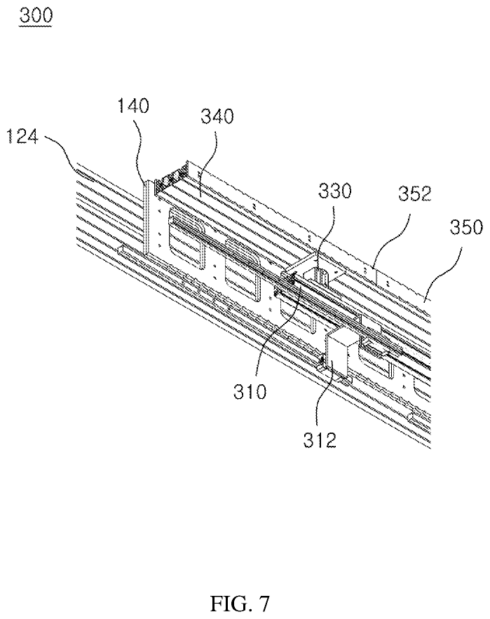

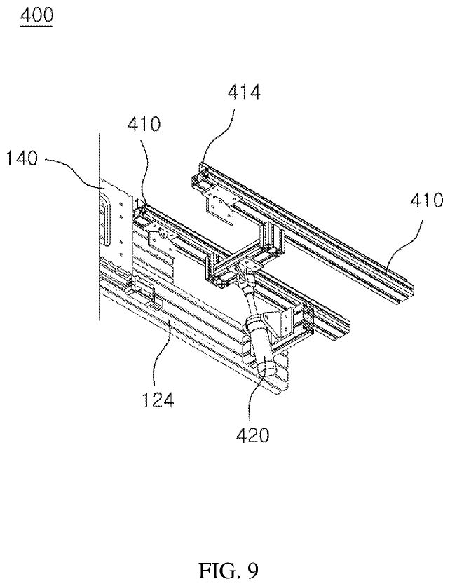

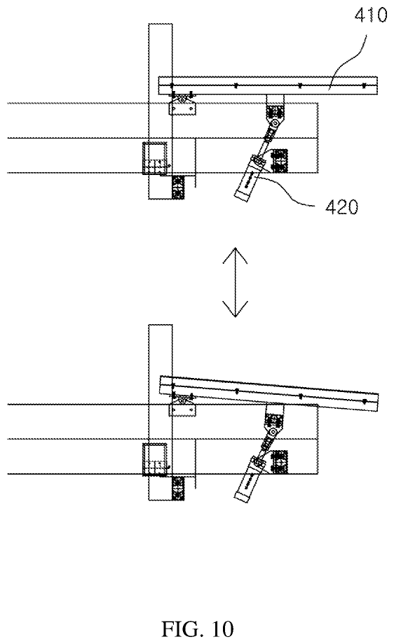

The present disclosure relates to an apparatus for manufacturing eco-friendly straws. As shown in FIGS. 2 to 15, the apparatus may include: a supply unit 200 configured to supply a raw material; a processing unit 100 configured to process the raw material; a transfer unit 300 configured to move the raw material supplied from the supply unit 200 to a position for processing in the processing unit 100; and a polishing unit 500 to polish the inner surface of a straw.

According to the present disclosure, by automatically performing all the manufacturing processes including the supply, processing, transfer, and polishing of the raw material, the entire process may be speedily performed to improve manufacturing efficiency and reduce manufacturing costs.

The above raw material is wood processed and molded into a circular bar. Teak wood, jabon wood, mahogany or sonokeling wood, etc., which are mainly found in Southeast Asia, may be used as the raw material, but is not limited thereto.

In the present disclosure, since a hole is formed in the center of the wooden raw material and processed into a straw, environmental pollution may be prevented, and the recycling rate may be increased because it can be used several times instead of one time.

In case the eco-friendly straw made of wood is damaged, it may be collected and used as a raw material for making paper. In addition, since the wooden straw emits no pollutants even if it is incinerated, it is easy to dispose of and does not harm the environment at all.

The processing unit 100 may include: a main body consisting of a lower frame 120 and an upper frame 130; a processing support plate 140 installed along a longitudinal direction on each side of the lower frame 120, and in which processing grooves 142 into which the raw material is inserted are formed at regular intervals on the upper portion thereof; and a drilling device 160 installed on the side of the main body 110 to process a hole in the raw material.

The lower frame 120 may include: a base frame 122 forming a bottom portion; and a lower side plate 124 installed on each side of the base frame 122 to protrude upward. The processing support plate 140 is installed on the inner surface of the lower side plate 124 to protrude upward, so that the raw material is supplied from the supply unit 200 located in the front of the main body 110 by the transfer unit 300, and the drilling device 160 makes a hole on each side of the raw material.

Meanwhile, on each side of the base frame 122 or on each side of the lower side plate 124 forming the lower frame 120, a main support 126 is installed to protrude upward, and the upper frame 130 may be installed on the main support 126.

The upper frame 130 may include: an upper side plate 132 installed on the upper part of the main support 126; and a reinforcing bar 134 connecting the lower portions of the pair of upper side plates 132.

In addition, the upper frame 130 may further include a fixing device 150 for fixing the raw material. The fixing device 150 may include: a pressing actuator 152 installed on the reinforcing bar 134 forming the upper frame 130; and a pressing member 154 that is installed under the pressing actuator 152, and ascends and descends.

At this time, a pair of the pressing member 154 is provided at a position corresponding to the position of the pair of processing support plates 140, and a fixing plate 153 is installed beneath the pressing actuator 152 so that each pressing member 154 may be fixedly installed at each end of the fixing plate 153.

As the fixing device 150 presses and fixes the raw material accommodated in the processing groove 142 downward, the raw material is not shaken, so that the processing process may be performed stably when making a hole in the raw material using the drilling device 160.

On the lower surface of the pressing member 154, an elastic member 155 may be further installed. As the elastic member 155 evenly distributes the pressure pressing the raw material made of wood over the entire surface, the raw material is firmly fixed so as not to be damaged.

Meanwhile, the drilling device 160 may include: a mounting plate 162 on which a drill 161 for drilling a hole in the raw material is installed; and a drive motor 163 connected to a speed reducer (not shown) provided inside the installation plate 162.

An auxiliary support 123 is installed on each side of the base frame 122 so as to protrude upward, and a processing actuator 165 is installed on the auxiliary support 123 to press the mounting plate 162 with the drill 161 installed in the direction of the raw material to make a hole in the raw material.

The mounting plate 162 is provided with a guide bar 164 to pass through front and rear to enable stable processing by moving without shaking. A rod 166 is provided in the processing actuator 165 so as to pass through front and rear, and a support jaw 167 enclosing the rod 166 protruding to the rear of the processing actuator 165 is installed by screwing, etc., to be movable.

By adjusting the position of the support jaw 167 and setting the limit of the rod 166 protruding forward by the processing actuator 165, the depth of the hole drilled in the raw material may be adjusted.

The drilling device 160 is installed so as to be movable up and down on the auxiliary support 123, so that the height thereof may be adjusted as needed.

In addition, a plurality of the drilling devices 160 are provided at regular intervals along the longitudinal direction on each side of the lower frame 120 constituting the main body 110, so that drilling is performed on both sides of the raw material at the same time as much as a set distance.

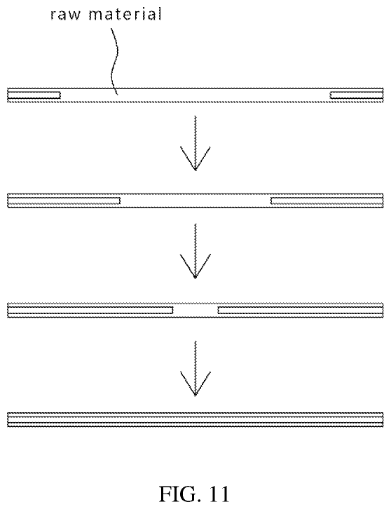

In other words, drilling devices 160 are installed so as to be symmetrical to each other on both sides of the main body 110 to drill both sides of the raw material by a set distance, and the plurality of the drilling devices 160 are installed at regular intervals. As the drilling devices 160 move rearward by the transfer unit 300, the raw materials are sequentially processed, and as shown in FIG. 11, the depth of the hollow becomes deeper as the raw material passes through the stages.

The drill 161 installed in the drilling device 160 is installed in plurality as shown in the drawing, and during drilling, a plurality of raw materials are processed as one set and are moved rearward in units of each set by the transfer unit 300 to be described later.

Although the drawing shows that the drill 161 is installed in plurality in the drilling device 160, a plurality of drills 161 may be installed, or only one drill 161 may be installed. Accordingly, a plurality of raw materials may be processed at once, or only one raw material may be processed depending on the drill installation situation.

In addition, as for the drilling devices 160 provided last among the drilling devices 160 provided at regular intervals on each side of the lower frame 120 of the main body 110, only one side of the drilling device 160 is operated to make a hole through the raw material completely.

Meanwhile, the supply unit 200 is installed at the front end of the lower frame 120 to supply raw materials. The supply unit 200 may include: a hopper 210 in which raw materials are accommodated therein; a supply conveyor 220 for moving the raw material discharged through an inlet 212 provided in the lower part of the hopper 210 to the rear; and a supply guide 230 installed to be inclined downwardly at the rear end of the supply conveyor 220 to supply raw materials to the transfer unit 300.

A support groove (not shown) is formed on the surface of the supply conveyor 220 to accommodate the bar-shaped raw material, and thus the raw material is supplied to the supply guide 230 at a set speed. At this time, a plate-shaped alignment guide (not shown) is formed on each side of the supply guide 230 to protrude upward to prevent the raw material from arbitrarily dislodging to the side.

A supply port 236 for supplying raw materials to the transfer unit 300 is formed on the lower end surface of the supply guide 230, and a supply control member 240 for controlling the arbitrary discharge of raw materials may be provided under the supply port 236 on each side thereof. The supply control member 240 may include: a support rod 242 for supporting both lower portions of the raw material formed in a bar shape; and a supply actuator 244 for lifting and lowering the support rod 242.

Due to this configuration, the supply and blocking of the raw material supplied through the supply unit 200 is controlled to supply the raw material only when the transfer unit 300 is located in the lower part of the supply unit 200, thereby preventing the raw material from being arbitrarily discharged.

In addition, it is natural that a transfer support plate 350 constituting the transfer unit 300 to be described later is positioned between a pair of support rods 242.

Meanwhile, a separation prevention bar 234 is further provided to be spaced apart from the lower surface of the supply guide 230 by a predetermined distance upward. The spacing distance of the separation prevention bar 234 is greater than the thickness of the raw material and is smaller than twice the thickness of the raw material.

Due to this configuration that prevents the raw material supplied from the supply conveyor 220 from being separated outward as well as from being double-stacked, it is possible to stably supply the raw materials one by one through the supply port 236.

The transfer unit 300 may include: a moving member 310 installed to be movable in the longitudinal direction at the inner lower portion of the lower frame 120; a lifting actuator 330 installed above the moving member 310; a lifting member 340 lifted and lowered by the lifting actuator 330; and a transfer support plate 350 installed along the longitudinal direction on each side of the lifting member 340.

The transfer support plate 350 is provided to be positioned between the processing support plates 140 installed on the lower frame 120 so as to move not only back and forth, but also up and down from the inside of the lower frame 120 together with the moving member 310.

On the upper portion of the transfer support plate 350, transfer grooves 352 are formed at regular intervals. The transfer grooves 352 are formed at the same intervals as the processing grooves 142 to prevent the raw material supplied from the supply unit 200 from being arbitrarily separated when inserted and moved.

In addition, moving brackets 312 are further provided under the moving member 310 at regular intervals along the longitudinal direction. The moving bracket 312 is formed in a “⊏” shape with an open lower side, and an LM block is installed on each side of the moving bracket so as to correspond to an LM guide installed along the longitudinal direction on the inner surface of the lower side plate 124 constituting the lower frame 120, so that the moving bracket may move back and forth stably.

A transfer actuator 320 is installed on the inner lower surface of the lower frame 120, and the end of the transfer actuator 320 is connected to the lower surface of the moving bracket 312 so that the moving member 310 moves back and forth under the control of the transfer actuator 320.

In addition to the transfer actuator 320 and the lifting actuator 330, the above-described supply actuator 244, pressing actuator 152, processing actuator 165, and a discharge control actuator 420 to be described later may be a cylinder as shown in the drawings, but are not limited thereto and may be formed of various known structures such as a motor.

Meanwhile, the transfer support plate 350 is formed long to cover both the supply unit 200 and the processing unit 100, and moves from the position below the supply unit 200 to the position of a discharge unit 400 to be described later to move the raw material and the processed straw forward by a set distance.

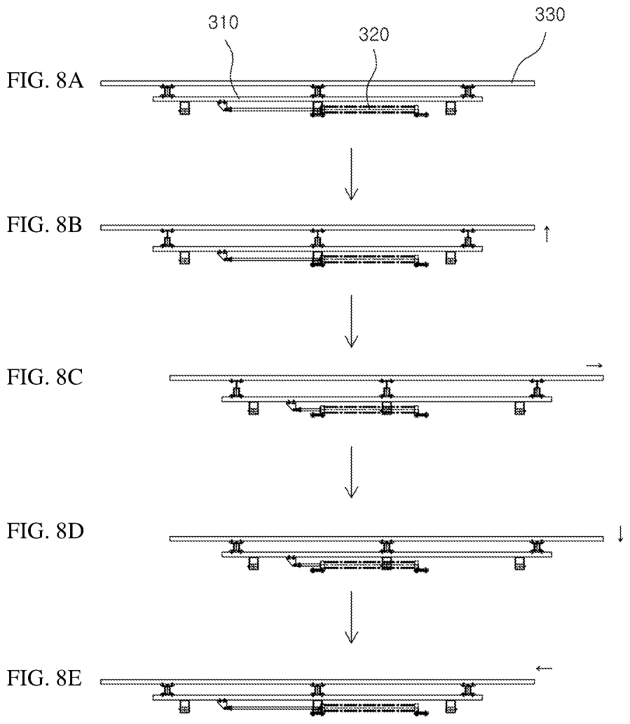

Now, the process in which the transfer support plate 350 moves will be described. As shown in FIGS. 8A to 8E, during the upward movement of the transfer support plate 350, the processed raw material seated in the processing groove 142 is inserted into the transfer groove 352 to be spaced apart from the processing groove 142 (see FIG. 8B). In this state, during the rearward movement of the transfer support plate 350, the processed raw material is moved to the next processing position of the processing unit 100 and, at the same time, the raw material supplied from the supply unit 200 is seated in the transfer groove 352 and moved to the processing position where the drilling device 160 of the processing unit 100 is installed (see FIG. 8C. Then, during the downward movement of the transfer support plate 350, each raw material inserted into the transfer groove 352 is inserted into the processing groove 142 of the processing support plate 140 (see FIG. 8D) before forward movement of the transfer support plate 350 is made (see FIG. 8E).

At this time, while the transfer support plate 350 moves from the rear to the front, the drilling device 160 drills a hole in the raw material. With this process as one cycle which repeats continuously, the raw material inserted into the processing groove 142 formed on the upper portion of the processing support plate 140 is moved to the processing groove 142 located at the rear, and is finally discharged through the discharge unit 400 to be described later.

Meanwhile, when the transfer support plate 350 is located below the supply unit 200, the transfer support plate 350 is positioned to be spaced apart from the supply port 236 by a predetermined distance. At this time, the spacing distance is greater than half the thickness of the bar-shaped raw material and smaller than the thickness of the raw material.

In addition, as the depth of the transfer groove 352 formed on the upper portion of the transfer support plate 350 is about half the thickness of the raw material, when the transfer groove 352 is positioned under the supply port 236 in the process of the transfer support plate 350 moving from the front to the rear, the raw material is inserted into the transfer groove 352 and completely discharged from the supply port 236, whereas when the upper surface of the transfer support plate 350 is placed under the supply port 236, the lower end of the raw material is supported on the upper surface of the transfer support plate 350, so that only half of the raw material protrudes downward and is discharged when the next transfer groove 352 is positioned under the supply port 236.

Accordingly, it is possible to accurately discharge the raw material to the position of the transfer groove 352 without additional control of the discharge.

Meanwhile, the polishing unit 500 may be further provided at the rear of the main body 110 constituting the processing unit 100. The polishing unit 500 is located in front of the discharge unit 400 to be described later, polishes the hollow of the straw to completely remove foreign matter, and then supplies the polished straw to the discharge unit 400 through the transfer unit 200.

The polishing unit 500 may include: a polishing device 510 installed on one side of the main body 110 to polish the hollow of the straw; and a foreign matter removal device 520 installed to face the polishing device 510 on the other side of the main body 110 to remove foreign matter from the hollow of the straw.

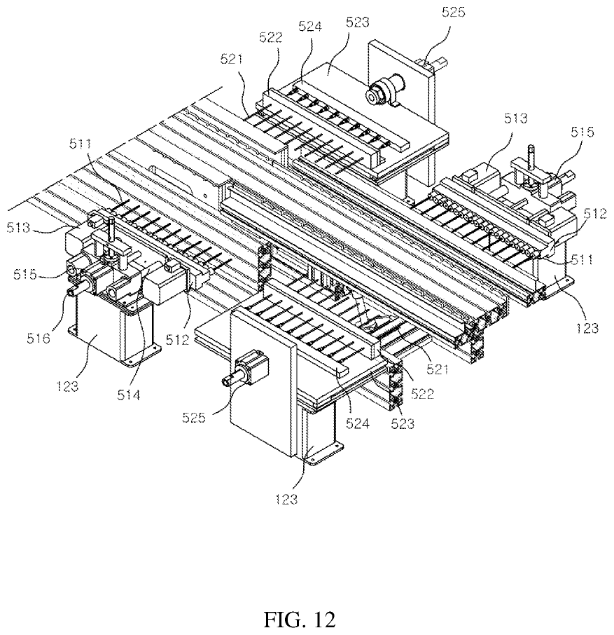

As shown in FIG. 12, two pairs of the polishing devices 510 and foreign matter removal devices 520 may be sequentially installed along the longitudinal direction in the rear of the main body 110, and the polishing device 510 located front and the polishing device 510 located rear may be installed diagonally opposite to each other with respect to the main body 110.

Thus, after the drilling device 160 constituting the processing unit 100 forms a hollow in the straw, the polishers are sequentially inserted into one side and the other side of the hollow to polish the hollow, and by allowing the polisher 511 constituting the polishing device 510 to be inserted through the hollow center of the straw, it is possible to polish the hollow of the straw from both directions and completely remove foreign matter inside, thereby preventing the foreign matter from being discharged during use by a user.

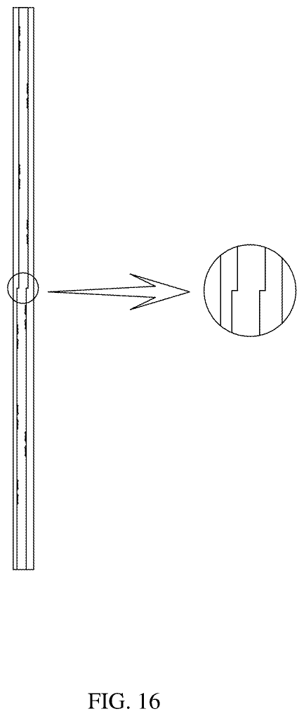

In other words, when processing the straw, a step may be formed in the center thereof as shown in FIG. 16 by performing the drilling operation on both sides of the straw. However, since the polisher 511 of the polishing device 510 is inserted to a position past the center of the straw, the step difference is eliminated and the entire inner circumferential surface of the hollow may be polished, so that foreign matter may be completely removed.

As shown in FIG. 12, the polishing device 510 may include: a polishing mounting plate 512 installed to be movable on the auxiliary support 123 installed on the side of the main body 110; the polisher 511 installed to be rotatable on the polishing mounting plate 512 to polish an inner circumferential surface of the straw; a drive motor 513 installed on the polishing mounting plate 512 to rotate the polisher 511; and a polishing actuator 515 installed on an upper first side of the auxiliary support 123 to move the polishing mounting plate 512.

A speed reducer (not shown) is provided inside the polishing mounting plate 512 to transmit the power of the drive motor 513 to the polisher 511 to rotate the polisher 511.

The polishing actuator 515 may consist of a motor. In addition, a male thread is formed on the outer circumferential surface of a polishing rod 516 connected to the polishing mounting plate 512, and as the polishing rod 516 moves at a constant force and speed by the action of the polishing actuator 515, the hollow of the straw may be completely polished.

The polishing actuator 515 is a motor having a rotating drum (not shown) therein. In addition, a female thread is formed on the inner circumferential surface of the rotating drum to move the polishing rod 516 having the male screw formed thereon back and forth, since the specific configuration is already known, description thereof will be omitted.

The polishing actuator 515 may be provided with an encoder (not shown). Since the degree of protrusion of the polishing rod 516 may be accurately determined by the action of the encoder, the position of the polishing rod 516 may be precisely controlled during polishing.

At this time, an LM guide (not shown) and an LM block (not shown) may be installed between the auxiliary support 123 and the polishing mounting plate 512, and the polishing mounting plate 512 may be provided with a guide bar 514 so as to pass through front and rear to enable stable processing by moving without shaking.

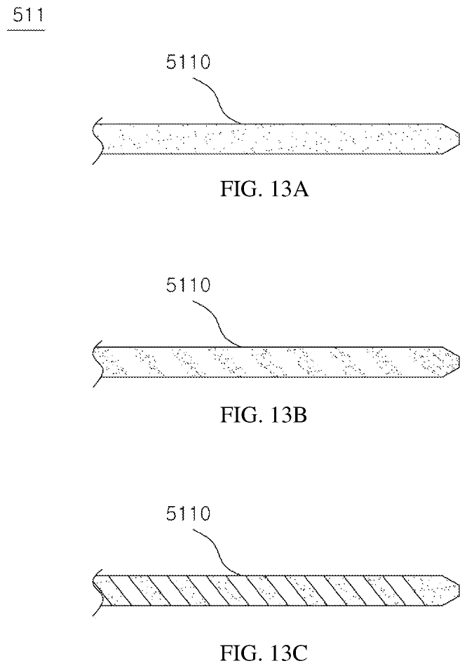

In addition, the polisher 511 may have a cylindrical polishing body 5110 having a larger diameter than the inner diameter of the hollow of the straw processed by the drilling device 160. A plurality of small protrusions may be formed at regular intervals on the surface of the polishing body 5110 as shown in FIG. 13A, small protrusions may be formed in a spiral shape as shown in FIG. 13B, or sandpaper with small protrusions may be attached in a spiral shape as shown in FIG. 13C.

By forming protrusions in a spiral shape or attaching sandpaper as shown in FIG. 13B or FIG. 13C, a screw-shaped space is formed between the protrusions or sandpaper, and thus when the hollow of the straw is polished, the abrasive dust generated may be easily discharged to the outside through the screw-shaped space, making it possible to perform the polishing operation more stably.

Meanwhile, as shown in FIG. 12, the foreign matter removal devices 520 may include: a moving plate 523 installed to be movable on the auxiliary support 123 installed on the side of the main body 110; a spray mounting plate 522 installed at the end of the moving plate 523; a spray pipe 521 installed on the spray mounting plate 522 to spray compressed air into the hollow of the straw; a compressed air distributor 524 installed on an upper first side of the moving plate 523 to equally distribute the compressed air to the spray pipe 521; and a spray actuator 525 installed on an upper first side of the auxiliary support 123 to move the moving plate 523.

Although not shown in the drawings, the compressed air distributor 524 receives compressed air from a compressed air supply device (not shown) such as a compressor that may be provided on the outside of the main body 110 and supplies the received compressed air to the spray pipe 521.

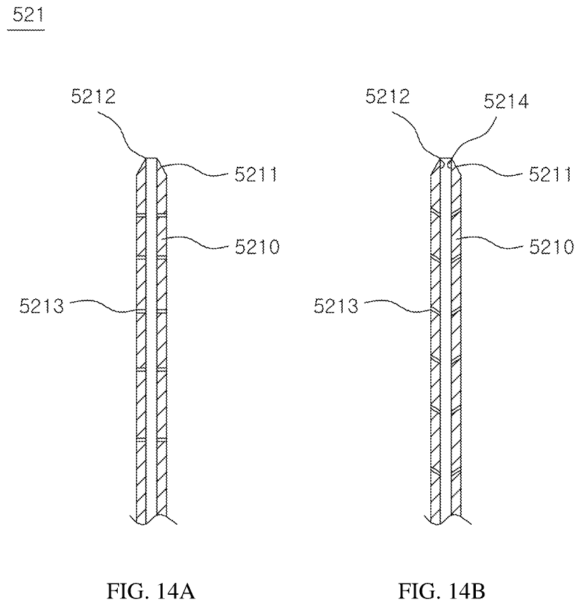

In addition, the spray pipe 521 may have a cylindrical spray body 5210 having a diameter smaller than the inner diameter of the hollow of the straw processed by the drilling device 160. As shown in FIG. 14A, the distal end of the spray body 5210 is formed with an inclined insertion portion 5211 to facilitate insertion into the hollow of the straw, a spray hole 5212 may be formed in the center of the inclined insertion portion 5211, and a plurality of spray holes 5213 may be formed at regular intervals along the longitudinal direction of the spray body 5210.

Therefore, compressed air is sprayed not only from the front but also from the side to completely remove foreign matter on the inner circumferential surface of the hollow of the straw.

In addition, as shown in FIG. 14B, a stepped portion 5214 may be formed to be convex inwardly at the end of the spray hole 5212. Accordingly, the compressed air sprayed to the end of the spray hole 5212 spreads outward. The spray holes 5213 formed at regular intervals in the spray body 5210 are formed to be inclined toward the end, so that foreign matter attached to the inner circumferential surface of the hollow may be more easily removed.

An LM guide (not shown) and an LM block (not shown) are installed between the auxiliary support 123 and the moving plate 523 so that the moving plate 523 may be easily moved. The spray actuator 525 may also consists of a motor, so that the spray pipe 521 may be stably moved.

Meanwhile, the polisher 511 and the spray pipe 521 may move at a speed set by the polishing actuator 515 and the spray actuator 525. While the polisher 511 is performing the polishing operation after being inserted into the hollow of the straw, the spray pipe 521 is also inserted into the hollow of the straw without coming into contact with the polisher 511, thereby reducing the time required for the polishing operation.

In general, when performing a polishing operation, the polisher 511 is inserted into the hollow of the straw, and after the polishing operation is performed, the polisher 511 is withdrawn from the hollow, and then the spray pipe 521 is inserted into the hollow to remove foreign matter.

However, in the present disclosure, when the end of the polisher 511 reaches a predetermined position while performing the polishing operation, the spray pipe 521 is inserted into the hollow, so that a considerable amount of time may be saved.

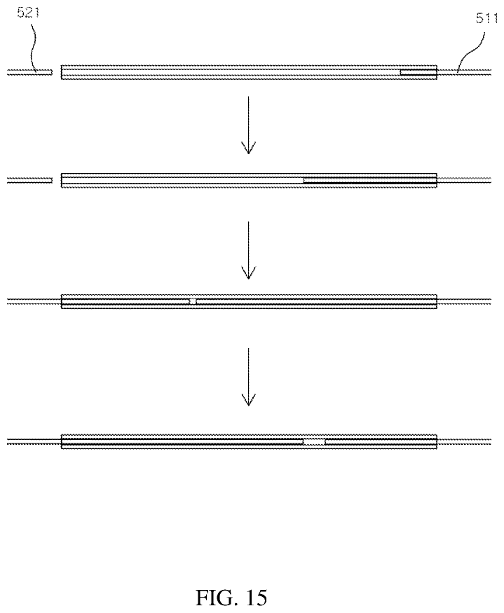

In an example of the above-described polishing operation, the polisher 511 and the spray pipe 521 may move at the same speed by the polishing actuator 515 and the spray actuator 525. As shown in FIG. 15, when the end of the polisher 511 constituting the polishing device 510 is inserted into the hollow of the straw and reaches a set position in the longitudinal direction, the spray pipe 521 of the foreign matter removal device 520 is inserted into the hollow of the straw.

At this time, the set position may preferably be one third point in the longitudinal direction in the hollow of the straw.

As previously described, the polishing actuator 515 and the spray actuator 525 are provided with encoders (not shown), so that the protrusion degrees of the polisher 511 and the spray pipe 521 may be properly checked, thereby stably controlling their positions.

Meanwhile, regarding the movement state of the polisher 511 and the spray pipe 521, as shown in FIG. 15, the polisher 511 is first inserted into one side of the straw to start polishing, and when the end of the polisher 511 reaches the set position of the straw, the spray pipe 521 starts moving while spraying compressed air. The end of the polisher 511 and the end of the spray pipe 521 become adjacent at the set position of the straw.

At this time, the set position may preferably be two thirds point in the longitudinal direction in the hollow of the straw.

Since the spray pipe 521 starts to move in a state spaced apart from the straw by a predetermined distance, when the polisher 511 is positioned at the two thirds point of the straw with respect to the insertion direction of the polisher 511, the polisher 511 and the spray pipe 521 are spaced apart by the spacing distance between the spray pipe 521 and the straw maintained before the spray pipe 521 is inserted into the straw.

When the polisher 511 moves in the direction to be drawn out from the straw by the control of the polishing actuator 515, the polisher 511 and the spray pipe 521 move while maintaining the above-described spacing distance, and after the spray pipe 521 reaches the two thirds point of the straw with respect to the insertion direction of the spray pipe 521, the spray pipe 521 moves in the opposite direction to be drawn out.

As such, in the present disclosure, by inserting the spray pipe 521 while the polisher 511 is still inside the straw, instead of inserting the spray pipe 521 in a state in which the polisher 511 is completely withdrawn, the time of the polishing process may be reduced to a minimum, thereby shortening the overall process.

The polishing device 510 and the foreign matter removal device 520 are formed as a pair on the left and right of the main body 110. In addition, as previously described, two pairs of the polishing devices 510 and foreign matter removal devices 520 are sequentially installed along the longitudinal direction in the rear of the main body 110, and the polishing device 510 located front and the polishing device 510 located rear may be installed diagonally opposite to each other with respect to the main body 110.

Therefore, it is possible to polish the inside of the straw more completely by polishing one side of the straw and then polishing the other side of the straw.

As for the straw that has been polished in this way, it is possible to maintain the best quality since the inner circumferential surface thereof is polished cleanly and foreign matter therein is completely removed by the compressed air sprayed from the spray pipe 521.

Meanwhile, at the farthest rear end of the lower frame 120, the discharge unit 400 for discharging the processed straw may be further provided. The discharge unit 400 may include: a discharge guide 410 hinged at both sides of the rear end part of the lower frame 120; and a discharge control actuator 420 connected to one side of the bottom of the discharge guide 410 and rotates up and down based on a hinge coupling part.

When the processed straw is supported on the discharge guide 410 by means of the transfer unit 300, the straw is discharged along the inclined portion formed by the discharge guide 410 as the end of the discharge guide 410 moves downward by the control of the discharge control actuator 420.

An alignment guide 414 may be further provided on the discharge guide 410, and the alignment guide 414 prevents the straw from dislodging to the side. A collection container 430 for collecting the discharged straws may be further provided at the rear of the discharge unit 400.

Although preferred embodiments of the present disclosure have been described above, the scope of the present disclosure is not limited thereto. The scope of the rights of the present disclosure extends to those that are substantially equivalent to the embodiments of the present disclosure, and various modifications may be made by those skilled in the art to which the present disclosure pertains without departing from the spirit of the present disclosure.

The present disclosure relates to an apparatus for manufacturing eco-friendly straws and, more particularly, to an apparatus for manufacturing eco-friendly straws, which prevents environmental pollution by using wood as a raw material for easy recycling and waste treatment, and improves manufacturing efficiency and product quality by automatically performing all manufacturing processes.

What is claimed is:

1. An apparatus for manufacturing eco-friendly straws, the apparatus comprising:
a supply unit configured to supply a raw material;
a processing unit configured to process the raw material; and
a transfer unit configured to transport the raw material supplied from the supply unit to a position for processing in the processing unit.

2. The apparatus for manufacturing eco-friendly straws of claim 1, wherein the processing unit comprises:
a main body;
a processing support plate installed along a longitudinal direction on each side of the main body, and in which processing grooves into which the raw material is inserted are formed at regular intervals on an upper portion thereof; and
a drilling device installed on a side of the main body to drill a hole in the raw material.

3. The apparatus for manufacturing eco-friendly straws of claim 2, further comprising:
a polishing unit provided at a rear of the main body to polish a straw processed,
wherein the polishing unit comprises:
a polishing device installed on a first side of the main body to polish a hollow of the straw; and
a foreign matter removal device installed to face the polishing device on a second side of the main body to remove foreign matter from the hollow of the straw.

4. The apparatus for manufacturing eco-friendly straws of claim 3, wherein the polishing device comprises:
a polishing mounting plate installed to be movable on an auxiliary support installed on a side of the main body;
a polisher installed to be rotatable on the polishing mounting plate to polish an inner circumferential surface of the straw;
a drive motor installed on the polishing mounting plate to rotate the polisher; and
a polishing actuator installed on an upper first side of the auxiliary support to move the polishing mounting plate,
wherein the polishing actuator consists of a motor to move a polishing rod connected to the polishing mounting plate with a constant force and speed.

5. The apparatus for manufacturing eco-friendly straws of claim 3, wherein the foreign matter removal device comprises:
a moving plate installed to be movable on an auxiliary support installed on a side of the main body;
a spray mounting plate installed at an end of the moving plate;
a spray pipe installed on the spray mounting plate to spray compressed air into the hollow of the straw;
a compressed air distributor installed on an upper first side of the moving plate to equally distribute the compressed air supplied from a compressed air supply device to the spray pipe; and
a spray actuator installed on an upper first side of the auxiliary support to move the moving plate.

6. The apparatus for manufacturing eco-friendly straws of claim 3, wherein when an end of a polisher provided in the polishing device is inserted into the hollow of the straw up to a set position, a spray pipe provided in the foreign matter removal device is inserted into the hollow of the straw by the foreign matter removal device.

7. The apparatus for manufacturing eco-friendly straws of claim 6, wherein the polisher is inserted into the hollow of the straw up to a position where the polisher does not collide with the spray pipe before moving in an opposite direction.
